(19) United States
(12) Patent Application Publication
(10) Pub. No.: US 2021/0034602 A1
(43) Pub. Date: Feb. 4, 2021

(54) IDENTIFICATION, RANKING AND PROTECTION OF DATA SECURITY VULNERABILITIES

(71) Applicant: INTERNATIONAL BUSINESS MACHINES CORPORATION, Armonk, NY (US)

(72) Inventors: Killian LEVACHER, DUBLIN (IE); Martin STEPHENSON, Co. Westmeath (IE); Stefano BRAGHIN, DUBLIN (IE); Spyridon ANTONATOS, DUBLIN (IE)

(73) Assignee: INTERNATIONAL BUSINESS MACHINES CORPORATION, Armonk, NY (US)

(21) Appl. No.: 16/526,684

(22) Filed: Jul. 30, 2019

(51) Int. Cl. G06F 16/23; G06N 20/00; G06F 21/62; G06F 16/11

(52) U.S. Cl. CPC G06F 16/2365; G06F 16/122; G06F 21/6218; G06N 20/00

(57) ABSTRACT

Various embodiments are provided for providing intelligent data security in a computing environment are provided. One or more data vulnerabilities may be identified from a plurality of data. Selected data having the one or more identified data vulnerabilities may be protected by applying one or more data protection policies or rules, wherein the selected data is de-identified.

### BACKGROUND OF THE INVENTION

### Field of the Invention

The present invention relates in general to computing systems, and more particularly to, various embodiments for identifying, ranking, and protecting data security vulnerabilities using a computing processor.

### Description of the Related Art

In today's interconnected and complex society, computers and computer-driven equipment are more commonplace. Processing devices, with the advent and further miniaturization of integrated circuits, have made it possible to be integrated into a wide variety of devices. The advent of computers and networking technologies have made possible the intercommunication of people from one side of the world to the other. However, ensuring data integrity and security are a continuous challenge to address.

### SUMMARY OF THE INVENTION

Various embodiments for providing intelligent data security in a shared computing file system in a computing environment are provided. In one embodiment, by way of example only, a method for providing assisted identification, scoring, ranking, and mitigation of data vulnerabilities in a computing environment, by a processor, is provided. One or more data vulnerabilities may be identified from a plurality of data. Selected data having the one or more identified data vulnerabilities may be protected by applying one or more data protection policies or rules, wherein the selected data is de-identified.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is an additional block diagram depicting various user hardware and cloud computing components functioning in accordance with aspects of the present invention;

FIG. 5 is a diagram depicting exemplary operations for identifying, ranking, and protecting data security vulnerabilities in a computing environment in a shared computing file system for a write operation in accordance with aspects of the present invention;

FIG. 6 is a diagram depicting exemplary operations for data vulnerability de-identification in accordance with aspects of the present invention;

FIG. 7 is a flowchart diagram depicting an exemplary method for identifying, ranking, and protecting data security vulnerabilities in accordance with aspects of the present invention; and

FIG. 8 is an additional flowchart diagram depicting an exemplary method for identifying, ranking, and protecting data security vulnerabilities in a computing environment in a computing environment in which aspects of the present invention may be realized.

### DETAILED DESCRIPTION OF THE DRAWINGS

In recent years, people have been witnessing data explosion with data being estimated in the order of zettabytes. Analysing this wealth and volume of data offers remarkable opportunities for growth in various industries and sectors (of types of entities (e.g., companies, governments, academic institutions, organizations, etc.). However, the majority of these datasets (e.g., healthcare data, telecommunication data, banking data, etc.) are proprietary and many contain personal (e.g., personal identifiable information “PII”) and/or business sensitive information. Examples of sensitive data include patient records, special housing information, tax records, governmental issued identification numbers (e.g., social security number), banking/financial data numbers (e.g., a bank account number, credit/debit card numbers, etc.), customer purchase records, academic records, mobile call detail records (CDR), etc. This type of data is often considered as private and confidential and should be protected from access by unauthorized users.

Moreover, across various industries, data (e.g., data related to customers, patients, or suppliers) is shared outside secure entity boundaries. Various initiatives (e.g., outsourcing tasks, performing tasks off-shore, etc.) have created opportunities for this data to become exposed to unauthorized parties, thereby placing data confidentiality and network security at risk. In many cases, these unauthorized parties do not need the true data value to conduct their job functions. Examples of data requiring de-identification include, but are not limited to, names, addresses, network identifiers, social security numbers and financial data. As a result, any entity, such as institutions, enterprises, businesses, companies, or agencies, which provides one or more services that access and/or process these types of sensitive data must be able to determine whether the sensitive data is at vulnerable to inappropriate disclosure, attack, compromise while determining when to take corrective action to eliminate, reduce, or mitigate the risk of exposure of vulnerable data.

For example, some application system such as, for example “data trusts” may be a legal entity that receives and stores data on behalf of another one in order to extract insights in a legally compliant fashion. In these cases, Data Privacy Officers (DPO) may be required to identify privacy issues with sample dataset in a short amount of time (e.g., “client onboarding”). During such period, DPOs are presented with samples of large (in number of records, that is number of data instances or entries in the dataset, and in number of dimensions, such as is number of fields of a dataset), and diverse datasets as well as how to protect sensitive information. That is, the amount of data which DPOs need to process may be very large with respect to the number of features to take into consideration and also with respect to the number of instances of each of these features to take into account. For example, consider a table with each of the columns of the table representing features (e.g., age, height, eye color, etc.) and each of the rows represents a person and thus both the number of columns and rows may be very large (e.g., 100 columns and 1 million rows). Given that the onboarding period is finite (e.g., between 2-6 weeks), the average DPO needs to be assisted in prioritizing the vulnerabilities detected by the risk assessment tools. Thus, a need exists for an intelligent and automated mechanism for both risk assessment and reasoning.

Thus, the present invention preserves and maintains data security in a shared computing file system by providing assisted identification, scoring, and mitigation of data vulnerabilities in a computing environment. One or more data vulnerabilities may be identified from a plurality of data. Selected data having the one or more protected data vulnerabilities may be protected by applying one or more data protection policies or rules, wherein the selected data is de-identified.

It should be noted in a general sense “vulnerability” may be defined as a weakness of particular data that may be exploited by an attacker to perform unauthorized actions on the data. More specifically, “vulnerability,” may be a characteristic of the data that makes it attackable from the privacy point of view such as, for example, if the data contains unique records, or plain PII. Additionally, “vulnerability” may refer to a flaw in data that creates a potential point of security compromise according to one or more data protection policies, rules, laws, or other legislation. That is, vulnerable data may be defined as data that fails to comply one or more data protection policies, rules, laws, or other legislation. In another aspect, vulnerable data may be defined as data that is vulnerable to linkage and other re-identification operation. In one aspect, examples of “vulnerable data” may include, but not limited to, one or more fields of a dataset containing PII, a combination of fields leading to identification of a small number of individuals, characteristics of transactions leading to unique identification of individuals, and the like. It should also be noted that not all the vulnerabilities identified by are actual vulnerability data. For example, consider a large dataset with 1 Terabyte (“TB”) of records, with an identifier (“ID”) column where and 1 ID matches against financial card number and the verification of that single ID can be postponed prioritizing other vulnerabilities.

In one aspect, the present invention provides for the identification and ranking of vulnerable data entities within databases, tabular, or comma separated values (“CSV”) files. However, the present invention may apply to any form of storage containing such entities for which relevant data protection policies can be provided.

In an additional aspect, the present invention provides for an intelligent system that 1) provides for the detection of potential privacy vulnerabilities within a given dataset, and 2) provides for the de-identification of vulnerable data entities identified based on one or more data protection policies. The present invention may use data properties (e.g., names, telephone numbers, emails etc.) and/or data protection policies that may specify/indicate how a selected entity type should be protected in order to comply with data protection policies, rules, laws, or other legislation. A vulnerability detection model may provide a list of privacy vulnerable entities, ranked in order of severity. A policy matcher may match data vulnerabilities with existing data protection policies. A de-identification engine may apply a policy to a target data entity.

In another aspect, one or more data owners may provide data that is required to be protected. The data owners may own data required to be protected. A data policy list, which may be provided by a data privacy team/group, may specify how a selected entity should be protected in order to comply with data protection policies, rules, laws, or other legislation. A list of non-actionable policies report may be generated for the one or more data owners. A data masked version of identified vulnerable data contained within the protection-required data may be provided. In one aspect, the present invention protects personal, sensitive, and/or proprietary information stored on data by inspecting data for potential data vulnerabilities. In one aspect, the present invention leverages data type identification, de-identification and anonymization operations to ensure required security guarantees are maintained and ensured. Additionally, a machine learning operation may perform one or more machine learning operations (e.g., natural language processing and/or artificial intelligence “AI” operations) to learn data that may be determined to be classified (e.g., private, personal, sensitive, and/or proprietary) and vulnerable. The selected portion of data that is determined to be classified/private and vulnerable data may be ranked and/or anonymized.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

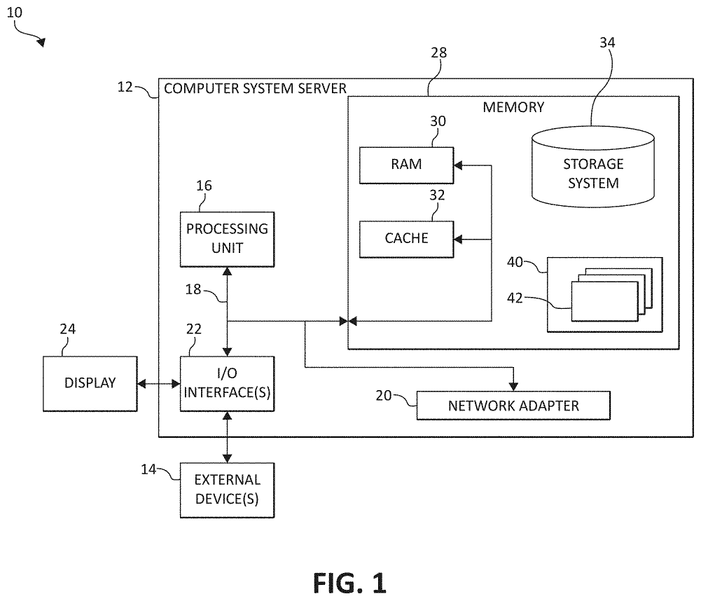

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in a moving vehicle. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

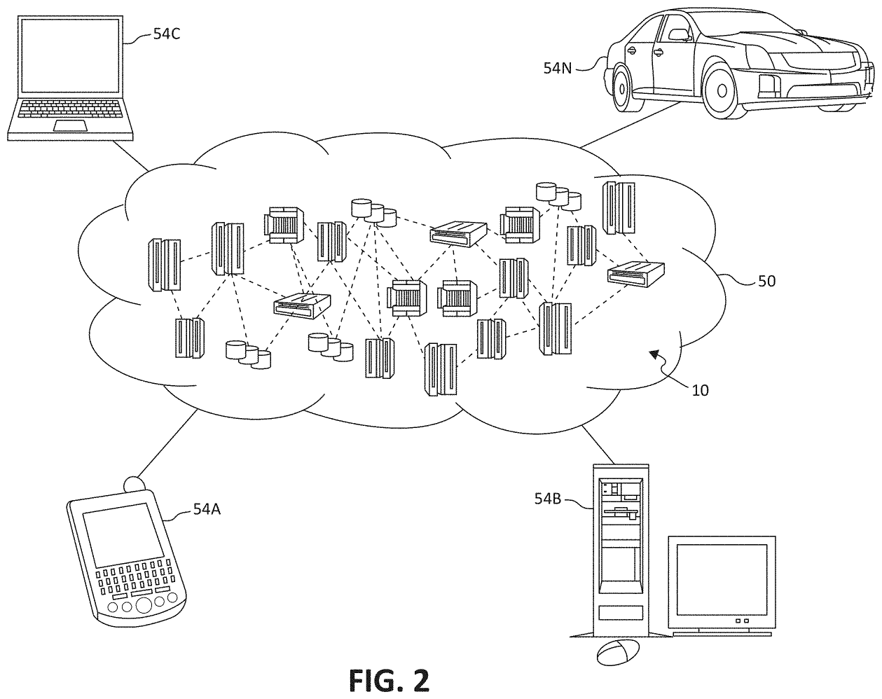

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

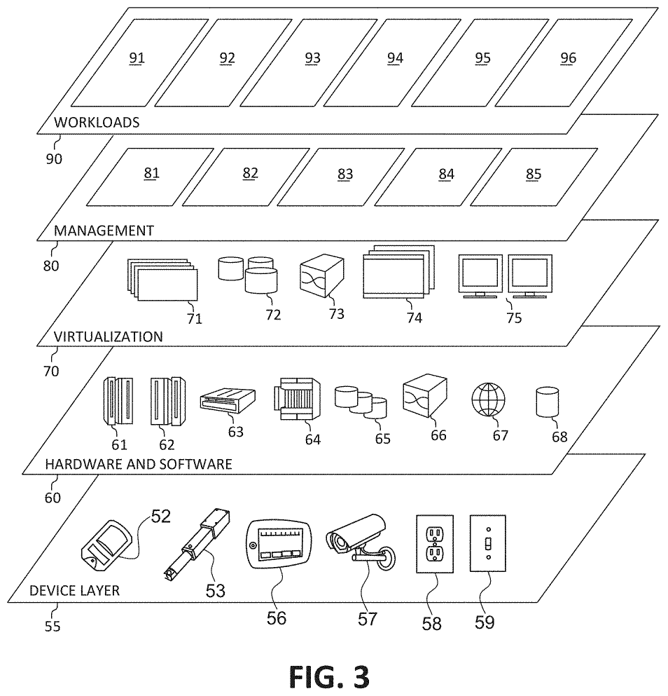

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 include hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for identifying and protecting data security vulnerabilities. In addition, workloads and functions 96 for identifying and protecting data security vulnerabilities may include such operations as data analysis (including data collection and processing) and data analytics functions. One of ordinary skill in the art will appreciate that the workloads and functions 96 for identifying and protecting data security vulnerabilities may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the mechanisms of the illustrated embodiments provide novel approaches for identifying and protecting data security vulnerabilities in a computing system. One or more data vulnerabilities may be identified from a plurality of data. Selected data having the one or more protected data vulnerabilities may be protected by applying one or more data protection policies or rules, wherein the selected data is de-identified.

In one aspect, the present invention may receive, interrupt, and/or intercept and act upon read and write system calls prior to reaching a computing storage system/device. In one aspect, the intercepting may be performed according to “Portable Operating System Interface” (“POSIX”) standards that defines how to interact with operating systems (“OS”) in a structured way. The present invention may identify and detect information (e.g., data that may be defined by a user or a machine learning operation that is private, personal, proprietary, and/or sensitive) and perform a data masking operation on the sensitive information. That is, the present invention may inspect a plurality of data during a write operation or a read operation and filtering selected data from the plurality of data according to one or more data security policies or rules prior to sending the plurality of data to or receiving the plurality of data from a shared computing file system.

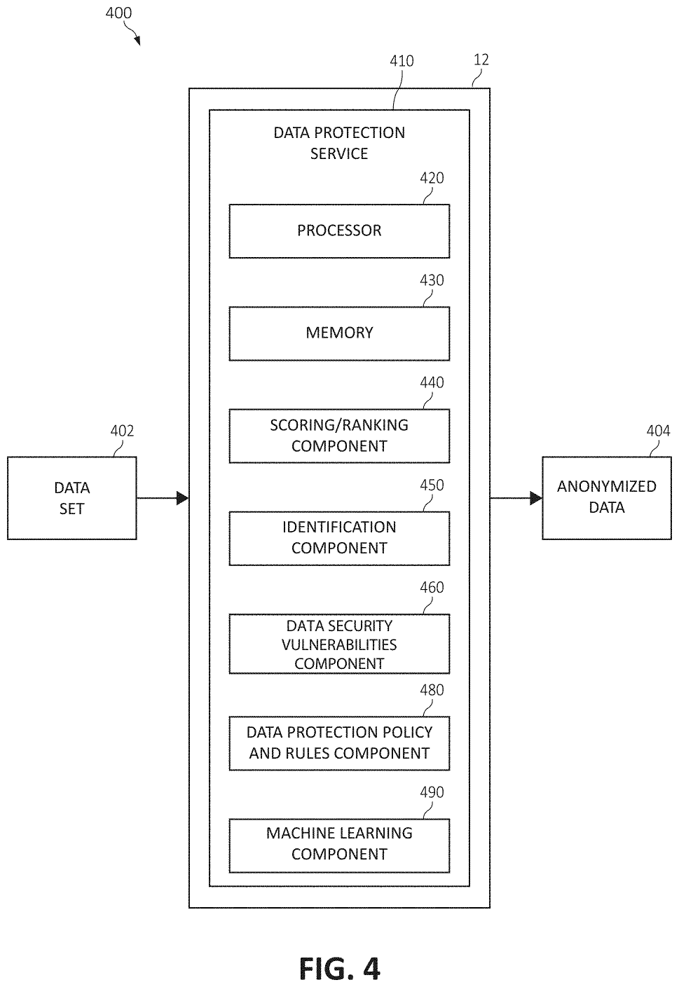

Turning now to FIG. 4, a block diagram depicting exemplary functional components 400 according to various mechanisms of the illustrated embodiments is shown for preserving data security in a shared computing file system. In one aspect, one or more of the components, modules, services, applications, and/or functions described in FIGS. 1-3 may be used in FIG. 4.

A data protection service 410 is shown, incorporating processing unit 420 to perform various computational, data processing and other functionality in accordance with various aspects of the present invention. The data protection service 410 may be included in computer system/server 12, as described in FIG. 1. The processing unit 420 (“processor”) may be in communication with memory 430.

The data protection service 410 may also include a scoring/ranking component 440, an identification component 450, a data security vulnerabilities component 460, a data protection policy and rules component 480, and a machine learning component 490, each of which may be in communication with each other.

In one aspect, data protection service 410 may in communication with and/or associated with one or more databases such as, for example, storage system 34 of FIG. 1, which may be internal to the data protection service 410 or may be external to the data management service 410. For example, the storage system 34 of FIG. 1 may be a third-party database in communication with and/or associated with the data protection service 410.

As one of ordinary skill in the art will appreciate, the depiction of the various functional units in data protection service 410 is for purposes of illustration, as the functional units may be located within the data protection service 410 or elsewhere within and/or between distributed computing components.

Responsive to receiving dataset 402 from a user and/or an enterprise (e.g., a data owner), such as a healthcare company, the identification component 450 may analyze the data to identify, detect, analyze, and/or intercept classified/private data (e.g., personal or sensitive information). The identification component 450 may identify one or more data vulnerabilities from a plurality of data.

The ranking/scoring component 440 may rank the one or more data vulnerabilities according to a degree of importance. The identification component 450, along with the data protection policy and rules component 480, may match the one or more data vulnerabilities with the one or more data protection policies, rules, laws, or other legislation.

The data security vulnerabilities component 460 may define one or more eligible data compliance formats for protecting selected data using the one or more data protection policies or rules. The data security vulnerabilities component 460 may provide a list of the selected data having potential data vulnerabilities, wherein the list of the selected data is ranked according to a degree of importance. Additionally, the data security vulnerabilities component 460 may generate a set of actionable and non-actionable data protection polies using a data protection vulnerability model and a list of the selected data having potential data vulnerabilities. The data security vulnerabilities component 460 may protect selected data having the one or more protected data vulnerabilities by applying one or more data protection policies or rules, wherein the selected data is de-identified.

The data security vulnerabilities component 460 may transform (e.g., filter, anonymize, replace, data mask, etc.) the vulnerable data (e.g., personal, sensitive, proprietary information) while maintaining and preserving the data/file format (e.g., preserve the data structure and size), which may be the anonymized/filtered data 404. For example, the data security vulnerabilities component 460 may filter or perform a data anonymization operation (e.g., data masking, k-anonymity, differential security, etc.) on the dataset 402 to produce the anonymized/filtered data 404. The data security vulnerabilities component 460 may, upon invocation from the identification component 150, apply the required transformations to the data blocks to be read/written according to the requirements (and/or one or more data protection policies, rules, laws, or other legislation).

The machine learning component 490 may train a data protection vulnerability model (e.g., a machine learning model), predict a ranking of the one or more data vulnerabilities according to a set of data vulnerabilities from the plurality of data, learn and apply actional data protection policies to the selected data and the one or more data security policies or rules, and/or collect feedback data for retraining the data protection vulnerability model. The machine learning component 490 may include and/or learn one or more of the following. 1) A set of security policies describing the type of vulnerable data (e.g., personal, sensitive, proprietary information) that the system needs to protect. 2) A set of exceptions, i.e., cases in which the classified/protected data (e.g., “private data” such as, for example, personal, sensitive, proprietary, or information) may be released. 3) A set of data enforcement/security enforcement rules describing how to process each type of classified/protected data (e.g., personal, sensitive, proprietary information).

The machine learning component 490 may learn the various classified/private data (e.g., personal, sensitive, proprietary information) for each type of user and/or entity (e.g., government, business, organization, academic institution, etc.) and assist the identification component 450, the data security vulnerabilities component 460, and/or the data protection policy and rules component 480 to identify, detect, analyze, and/or intercept classified/private data (e.g., personal or sensitive information) that may be vulnerable to attack, inappropriate disclosure, and/or manipulation. In one aspect, machine learning component 490 may include and/or access a knowledge domain that may include a variety of knowledge data such as, for example, data relating to the various classified/private data for each type of user and/or entity (e.g., government, business, organization, academic institution, etc.).

In one aspect, the various machine learning operations of the machine learning component 490, as described herein, may be performed using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

As one of ordinary skill in the art will appreciate, the data protection service 410 may implement mathematical modeling, probability and statistical analysis or modeling, machine reasoning, probabilistic logic, text data compression, or other data processing technologies to carry out the various mechanisms of the illustrated embodiments. In one aspect, calculations may be performed using various mathematical operations or functions that may involve one or more mathematical operations (e.g., using addition, subtraction, division, multiplication, standard deviations, means, averages, percentages, statistical modeling using statistical distributions, by finding minimums, maximums or similar thresholds for combined variables, etc.).

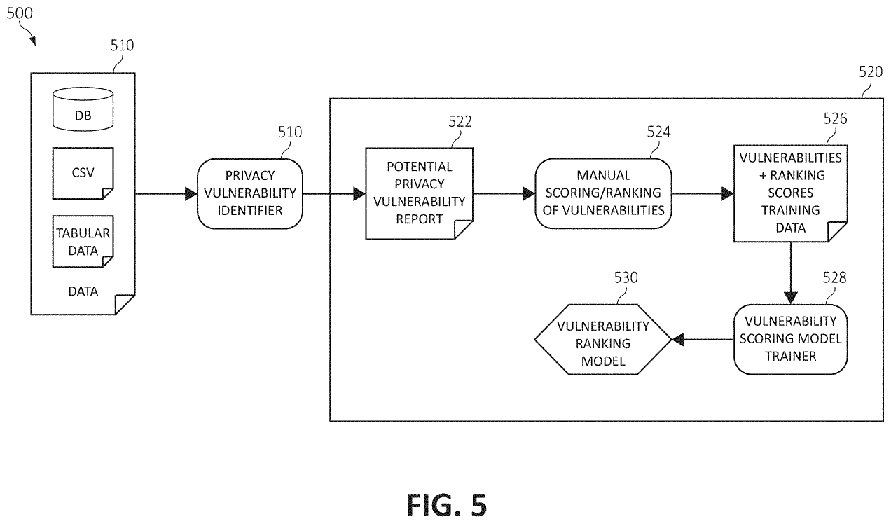

In view of the foregoing, consider the following operation example illustrated in FIGS. 5-7 of the implementation of the aforementioned functionality. Turning now to FIG. 5, an exemplary operation for identifying, ranking, and protecting data security vulnerabilities in a computing environment is depicted, in which various aspects of the illustrated embodiments may be implemented. Also, one or more components, functionalities, and/or features of FIGS. 1-4 may be implemented in FIG. 5. Repetitive description of like elements, components, modules, services, applications, and/or functions employed in other embodiments described herein is omitted for sake of brevity.

As shown, the various blocks of functionality are depicted with arrows designating the blocks' 500 relationships with each other and to show process flow. Additionally, descriptive information is also seen relating each of the functional blocks 500. As will be seen, many of the functional blocks may also be considered “modules” of functionality, in the same descriptive sense as has been previously described in FIGS. 1-4. With the foregoing in mind, the module blocks 500 may also be incorporated into various hardware and software components of a system for identifying and protecting data security vulnerabilities in accordance with the present invention. Many of the functional blocks 500 may execute as background processes on various components, either in distributed computing components, or on the user device, or elsewhere, and generally unaware to the user performing.

Starting in block 510, data from one or more data sources such as, for example, a database “DB,” a CVS file, tabular data may be provided for a privacy vulnerability identifier 512 to identify the data 510 that is vulnerable data. For example, a data owner may provide data 510 to be protected. A DPO team may use the privacy vulnerability identifier 512 to identify data entities that should be protected.

A potential privacy vulnerability report may be generated that indicates a list of data entities that should be protected, as in block 522. The data entities that should be protected may be scored and ranked such as, for example, by scoring and ranking the vulnerability of the data according to a degree of importance (and/or even according to a probability/potential of being vulnerable data), as in block 524. That is, the data vulnerabilities of data 510 may be ranked according to a degree of importance/severity of the vulnerabilities.

The ranked/scored data may be used to trainable data for a machine learning operation. That is, the ranking of the vulnerability of the data may be leveraged to generate training data., as in block 526. The machine learning operation may be used to train a vulnerability scoring model as in block 528. The vulnerability scoring model trainer may then be used to predict the ranking of a vulnerability given a set of vulnerabilities provided for a given dataset potential candidates for ML operation, as in block 530.

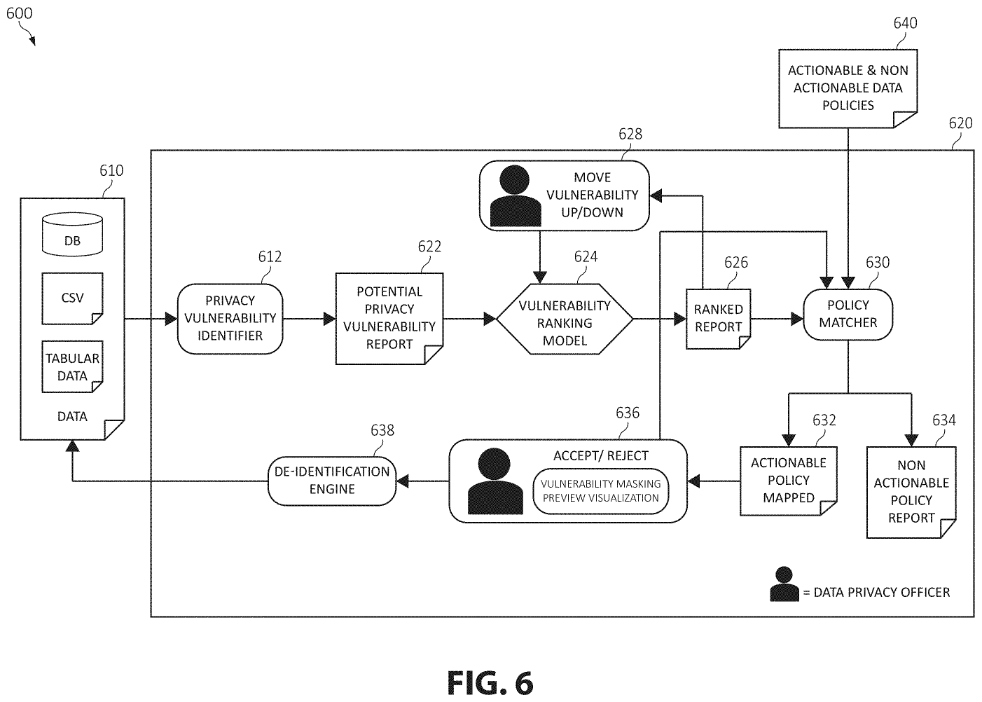

Turning now to FIG. 6, an exemplary operation for data vulnerability de-identification is depicted, in which various aspects of the illustrated embodiments may be implemented. Also, one or more components, functionalities, and/or features of FIGS. 1-5 may be implemented in FIG. 6. Similar to FIG. 5, the various blocks of functionality are depicted with arrows designating the blocks' 600 relationships with each other and to show process flow. Repetitive description of like elements, components, modules, services, applications, and/or functions employed in other embodiments described herein is omitted for sake of brevity.

Starting in block 610, data from one or more data sources such as, for example, a database “DB,” a CSV file, and/or tabular data may be provided for a privacy vulnerability identifier 612 to identify the data 610 that is vulnerable data (or has potential or probability to be vulnerable). That is, the privacy vulnerability identifier 612 may parse the data 610 to be protected to produce a list of potential vulnerabilities discovered.

For example, a data owner and a DTO team may provide data 610 to be protected and a set of data policies. The DTO team may use the privacy vulnerability identifier 612 to identify data entities that should be protected. In one aspect, data policies may include, for example, email addresses should be redacted (e.g., “actionable”). Also, a data policy may indicate that upon detection of PII in externalized documents, a data owner should be notified by written email (e.g., non-actionable). That is, the data policies, rules, regulations, law, or legislation may identify one or more “actionable” or “non-actionable” operations that should be performed.

A potential privacy vulnerability report may be generated that indicates a list of data entities that should be protected, as in block 622. The data entities that should be protected may be scored and ranked using a vulnerability scoring model such as, for example, by scoring and ranking the vulnerability of the data according to a degree of importance, as in block 624. The vulnerability scoring model may rank these data vulnerabilities in order of importance, which the vulnerability scoring model produces as a ranked list (e.g., ranked report), as in block 626.

The ranked list/report of vulnerabilities may be adjusted by moving up/down individual vulnerabilities as required (which adjustments may be automatically performed and/or performed by a data owner), as in block 628. These adjustments are thereafter incorporated within the Vulnerability Scoring Model to improve future ranking iterations occurring at block 624. This is the active learning step, in which can repeat the training phase injecting incorrect ranking as negative examples (e.g., to improve the quality) or correct ranking as positive examples (e.g., to strengthen the learned model). It should be noted that the user has only responsibility for validating the output of the ML model.

A policy matcher component may filter the list of potential data policies (e.g., data policies, rules, regulations, laws, legislation, etc.) provided in block 610 by the data privacy team) to produce a) a list of non-actionable policies and/or b) a list of actionable policies both relevant to the vulnerabilities discovered, as in block 630. That is, one or more actionable policies may be mapped to one or more data policies and vulnerable data, as in block 632 and one or more non-actionable policies may be mapped to one or more data policies and vulnerable data, as in block 634.

One or more changes (e.g., instructions described in a privacy policy suggested by a transformation mechanisms that transforms the data in such a way to remove or at least mitigate a protection/privacy vulnerability) may be accepted and/or rejected such as, for example, automatically using a machine learning operation, using a data protection team/office, or a combination thereof, as in block 636. That is, data masking may be employed to transform the data to remove or mitigate a data vulnerability. In one aspect, the data protection team/officer may be provided vulnerability masking preview visualization.

It should be noted that if the feedback indicates the changes are rejected, a potential impact of the examined data privacy policy may be reviewed/analyzed through the vulnerability masking preview visualization. Said differently, for example, a data owner (e.g., a user of the illustrated embodiments described herein) may review a potential impact of the suggested/generated data privacy policy (i.e., the list of transformation suggested to be applied to the data to remove/reduce the detected vulnerabilities). The user is able to accept, reject or modify such policy. The feedback is taken into consideration by the machine learning operation to “learn” what the user desires/wants and how vulnerabilities should be addressed, according to user and data.

Upon rejection, the policy matcher attempts to generate a new set of actionable policy actions, which may be sent to the policy matcher in block 630. For all changes/edits that are accepted, a de-Identification engine may edit the data to be protected according to one or more appropriate or relevant data protection policies, as in block 638. The edited data may be returned to block 610.

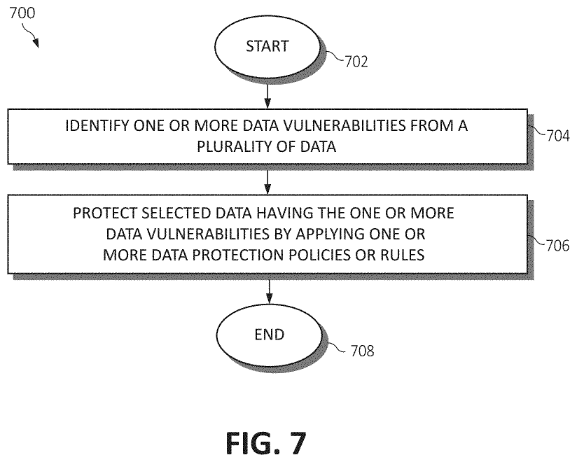

Turning now to FIG. 7, a method 700 for identifying, ranking, and protecting data security vulnerabilities in a computing environment is depicted, in which various aspects of the illustrated embodiments may be implemented. The functionality 700 may be implemented as a method executed as instructions on a machine, where the instructions are included on at least one computer readable storage medium or one non-transitory machine-readable storage medium. The functionality 700 may start in block 702.

One or more data vulnerabilities may be identified from a plurality of data, as in block 704. Selected data having the one or more data vulnerabilities may be protected by applying one or more data protection policies or rules, wherein the selected data is de-identified, as in block 706. The functionality 700 may end in block 708.

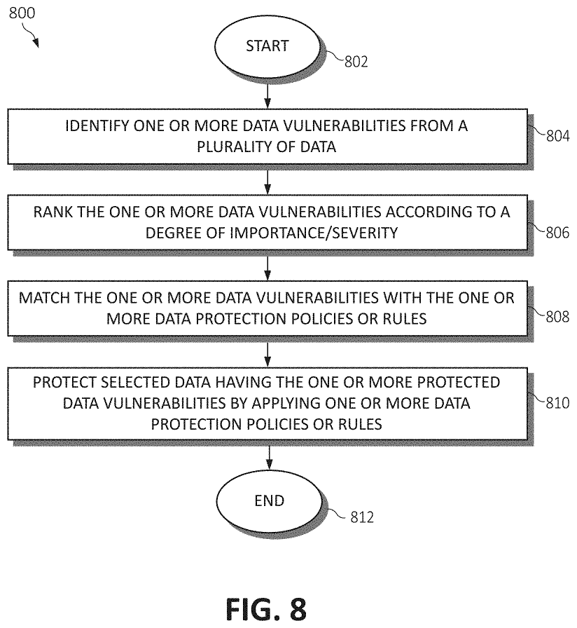

Turning now to FIG. 8, a method 800 for identifying, ranking, and protecting data security vulnerabilities in a computing environment is depicted, in which various aspects of the illustrated embodiments may be implemented. The functionality 800 may be implemented as a method executed as instructions on a machine, where the instructions are included on at least one computer readable storage medium or one non-transitory machine-readable storage medium. The functionality 800 may start in block 802.

One or more data vulnerabilities may be identified from a plurality of data, as in block 804. The one or more data vulnerabilities may be ranked according to a degree of importance/severity, as in block 806. The one or more data vulnerabilities may be matched with the one or more data protection policies or rules, as in block 808. Selected data having the one or more protected data vulnerabilities may be protected by applying one or more data protection policies or rules (e.g., data protection policies, rules, regulations, laws, legislation, etc.), as in block 810. The functionality 800 may end in block 808.

In one aspect, in conjunction with and/or as part of at least one block of FIGS. 7-8, the operations 700 and/or 800 may include one or more of each of the following. The operations 700 and/or 800 may define one or more eligible data compliance formats for protecting selected data using the one or more data protection policies or rules. The operations 700 and/or 800 may provide a list of the selected data having potential data vulnerabilities, wherein the list of the selected data is ranked according to a degree of importance and generate a set of actionable and non-actionable data protection polies using a data protection vulnerability model and a list of the selected data having potential data vulnerabilities.

The operations 700 and/or 800 initiate a machine learning model to: 1) train a data protection vulnerability model; 2) predict a ranking of the one or more data vulnerabilities according to a set of data vulnerabilities from the plurality of data; 3) learn and apply actional data protection policies to the selected data and the one or more data security policies or rules; and/or 4) collect feedback data for retraining the data protection vulnerability model.

The operations of 800 may replace the selected data with anonymized data according to the one or more data security policies or rules, and/or filter the selected data identified in a list of potential vulnerabilities.

The operations of 800 may define the one or more data security policies or rules to include types and formats of data for preserving data security, define the one or more data security policies or rules to one or more operations to identify the list of potential vulnerabilities, and/or apply/match the one or more data security policies or rules to data having one or more potential vulnerabilities using a machine learning operation.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by a processor, for providing intelligent data security in a computing environment, comprising:
identifying one or more data vulnerabilities from a plurality of data; and
protecting selected data having the one or more data vulnerabilities by applying one or more data protection policies or rules, wherein the selected data is de-identified.

2. The method of claim 1, further including ranking the one or more data vulnerabilities according to a degree of importance.

3. The method of claim 1, further including matching the one or more data vulnerabilities with the one or more data protection policies or rules.

4. The method of claim 1, further including defining one or more eligible data compliance formats for protecting selected data using the one or more data protection policies or rules.

5. The method of claim 1, further including providing a list of the selected data having potential data vulnerabilities, wherein the list of the selected data is ranked according to a degree of importance.

6. The method of claim 1, further including generating a set of actionable and non-actionable data protection polies using a data protection vulnerability model and a list of the selected data having potential data vulnerabilities.

7. The method of claim 1, further including initiating a machine learning model to:
train a data protection vulnerability model;
predict a ranking of the one or more data vulnerabilities according to a set of data vulnerabilities from the plurality of data;
learn and apply actional data protection policies to the selected data and the one or more data security policies or rules; and
collect feedback data for retraining the data protection vulnerability model.

8. A system providing intelligent data security in a computing environment, comprising:
one or more computers with executable instructions that when executed cause the system to:
identify one or more data vulnerabilities from a plurality of data; and
protect selected data having the one or more data vulnerabilities by applying one or more data protection policies or rules, wherein the selected data is de-identified.

9. The system of claim 8, wherein the executable instructions rank the one or more data vulnerabilities according to a degree of importance.

10. The system of claim 8, wherein the executable instructions match the one or more data vulnerabilities with the one or more data protection policies or rules.

11. The system of claim 8, wherein the executable instructions define one or more eligible data compliance formats for protecting selected data using the one or more data protection policies or rules.

12. The system of claim 8, wherein the executable instructions provide a list of the selected data having potential data vulnerabilities, wherein the list of the selected data is ranked according to a degree of importance.

13. The system of claim 8, wherein the executable instructions generate a set of actionable and non-actionable data protection polies using a data protection vulnerability model and a list of the selected data having potential data vulnerabilities.

14. The system of claim 8, wherein the executable instructions initiate a machine learning model to:
train a data protection vulnerability model;
predict a ranking of the one or more data vulnerabilities according to a set of data vulnerabilities from the plurality of data;
learn and apply actional data protection policies to the selected data and the one or more data security policies or rules; and
collect feedback data for retraining the data protection vulnerability model.

15. A computer program product for, by a processor, providing intelligent data security in a computing environment, the computer program product comprising a non-transitory computer-readable storage medium having computer-readable program code portions stored therein, the computer-readable program code portions comprising:
an executable portion that identifies one or more data vulnerabilities from a plurality of data; and
an executable portion that protects selected data having the one or more data vulnerabilities by applying one or more data protection policies or rules, wherein the selected data is de-identified.

16. The computer program product of claim 15, further including an executable portion that:
ranks the one or more data vulnerabilities according to a degree of importance; or
matches the one or more data vulnerabilities with the one or more data protection policies or rules.

17. The computer program product of claim 15, further including an executable portion that defines one or more eligible data compliance formats for protecting selected data using the one or more data protection policies or rules.

18. The computer program product of claim 15, further including an executable portion that provides a list of the selected data having potential data vulnerabilities, wherein the list of the selected data is ranked according to a degree of importance.

19. The computer program product of claim 15, further including an executable portion that generates a set of actionable and non-actionable data protection polies using a data protection vulnerability model and a list of the selected data having potential data vulnerabilities.

20. The computer program product of claim 15, further including an executable portion that:
trains a data protection vulnerability model;
predicts a ranking of the one or more data vulnerabilities according to a set of data vulnerabilities from the plurality of data;
learns and applies actional data protection policies to the selected data and the one or more data security policies or rules; and
collects feedback data for retraining the data protection vulnerability model.
